(19) United States
(12) Patent Application Publication
(10) Pub. No.: US 2007/0017957 A1
(43) Pub. Date: Jan. 25, 2007

(54) Method and apparatus for detecting parameters of a liquid metal in a container

(75) Inventors: Riccardo Tascone, Torino (IT); Guiseppe Virone, Castelnuovo Don Bosco (IT); Augusto Olivieri, Pianezza (IT); Oscar Antonio Peverini, Buttigliera Alta (IT)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Fondazione Torino Wireless, Torino (IT)

(21) Appl. No.: 11/446,474

(22) Filed: Jun. 2, 2006

(30) Foreign Application Priority Data
Jun. 3, 2005 (EP) 05012031.0

(51) Int. Cl. A47J 36/02

(52) U.S. Cl. 228/101

(57) ABSTRACT

A method and an apparatus for measuring simultaneously and in a reliable manner both the level of molten metal in a casting mold and the depth of molding powder floating over the molten metal, wherein an electromagnetic open cavity is formed on the upper inlet aperture of a casting mold and electromagnetic signals are introduced into the cavity by means of an emitting device. The electromagnetic signals exiting the cavity are then detected and a relationship is established between the detected properties of the electromagnetic cavity and the level of molten metal and depth of molding powder.

This application claims the priority of European patent application no. EP 05012031.0, filed Jun. 3, 2005.

### BACKGROUND

The present invention relates to a method and an apparatus for detecting and/or measuring predefined parameters of a liquid metal in a container. In particular, the present invention relates to a method and an apparatus for detecting the depth of mold powder in a casting mold and the level of liquid metal in said casting mold.

In FIG. 1, the basic elements of a continuous casting process are depicted. In particular, in FIG. 1, reference numeral 1 identifies a casting mold adapted to be supplied with a liquid metal and to discharge solidified metal; in this respect, it has to be noted that the liquid metal is introduced into the casting mold 1 through an inlet aperture la, while solidified metal 5 is discharged from the casting mold 1 through an outlet aperture 1b. Still in FIG. 1, reference numerals 3 and 4 identify a container in which the liquid metal is stored while reference numeral 4 identifies the liquid metal stored in the container. Moreover, reference numeral 2 identifies a nozzle through which the liquid metal 4 is discharged from the intermediate container 3 and introduced into the casting mold 1. Finally, in FIG. 1, reference numeral 6 identifies rollers by means of which the solidified metal is extracted from the casting mold 1 in the form of a solid bar, the solid bar being identified in FIG. 1 with the reference numeral 7. Reference numeral 5 in FIG. 1 identifies the portion of the liquid metal still contained in the solid bar 7.

In a continuous casting process, known in the art and carried out by means of an apparatus as depicted in FIG. 1, a supply of molten metal 4 is maintained in an intermediate container 3. The intermediate container 3 comprises a bottom outlet from which the metal flows into a mold 1 through a nozzle 2. The mold 1 is usually cooled by means of water-cooling means (not depicted in FIG. 1) that chills and solidifies the molten metal so that it exits the outlet aperture 1b of the mold as a solid bar 7. In particular, as depicted in FIG. 1, the metal bar 7 still comprises, in the proximity of the outlet aperture 1b of the mold 1, liquid or semi liquid metal 5, while at a certain distance from said outlet aperture 1b, the metal bar 7 no longer contains liquid or semi liquid metal but only solid metal. As depicted in FIG. 1, the bar 7 follows a curved path, defined by a plurality of rollers 26 disposed on both sides of the solid bar 7, which cooperate to continuously feed the solidified bar 7. Finally, means downstream of the rolls 6 (not depicted in FIG. 1) separate lengths of the bar 7 for further processing. Moreover, mold powder (not depicted in FIG. 1) is introduced into the mold 1 on the surface of the liquid metal; to this end, several means are known for working the mold powder and introducing same into the mold 1, this means not being depicted in FIG. 1 for reasons of clarity. The mold powder is introduced into the casting mold 1 for several purposes, such as, for example, for lubricating the walls of the casting mold 1 and/or for controlling the speed of solidification of molten and/or liquid metal.

In a continuous casting process carried out by means of a prior art apparatus as depicted in FIG. 1, it assumes great relevance to measure in a reliable manner both the depth of mold powder and the level of liquid metal in the cavity; in fact, measuring the depth of the powder and the level of liquid metal allows to control these two parameters accordingly. For instance, if the depth of molding powder in the mold is to low, the speed at which the molding powder is introduced into the mold may be increased, accordingly. Conversely, if the depth of molding powder in the mold 1 is too high, the speed at which molding powder is introduced into the mold 1 may be reduced. In the same way, if it arises that the level of liquid metal in the mold 1 is too low either the rate at which liquid metal is supplied to the mold may be increased or the speed at which the solidified bar 7 is extracted may be decreased. Conversely, if it is detected that the liquid of molten metal in the mold is too high, either the rate at which molten metal is introduced into the mold 1 may be decreased or the speed at which the solid bar 7 is extracted from the mold 1 may be increased.

Several methods and apparatuses have been proposed over the years for the purpose of measuring the depth of molding powder and the level of molten metal in a casting mold. For instance, European patent application no. EP0658747 discloses a continuous casting mold comprising means for gauging the level of molten metal in the mold so that it can be maintained near the top of the mold without overflowing. The known measuring device comprises a radioactive source on one side of the mold and a scintillation crystal detector on the opposite side of the mold. The radioactive source is a continuously disintegrating material, which permits particles/energy in the form of α, β, and γ rays in transmuting to a lighter, elemental material. The detector is responsive to the impingement of these particles/energy to provide a given signal level which is inversely proportionate to the square of the distance between the source and the detector. The intensity of the radiation impinging on the detector and the output signal therefrom, is inversely proportional to the degree to which molten metal absorbs radiation, which in turn is a function of the level of the molten metal in the mold. Means are also disclosed in the above identified European patent application for gauging the level of molten metal in the mold as a function of the level of molten metal detected in the tube.

A further solution for measuring the level of molten metal in a continuous casting mold is known from European patent application EP0859223. In particular, the apparatus for detecting the level of liquid metal within the mold disclosed in this patent application includes an array of radiation detectors positioned to one side of the mold and extending to positions above and below the expected height of liquid metal. Moreover, a source of radiation photons is positioned on the mold side opposite to that on which the detector array is positioned, and means are provided for counting the number of incident photons received by each radiation detector or neighboring detectors in unit time. The number of incident photons received provides a measure of the height of liquid metal within the mold. Signals representative of the measures of liquid metal height may therefore be employed as control signals for controlling automatically or periodically the level of liquid metal inside the mold.

According to a further prior art method for detecting and/or measuring the level of liquid metal in a casting mold an inductive device is used, adapted to excite parasite electrical currents in the molten metal so that the level of liquid metal within the mold may be detected as a function of the power dissipated by the system.

According to still a further solution known in the art, the temperature of the walls of the mold is measured and the level of molten metal in the mold is detected computed as a function of the temperature measured.

The methods and/or apparatuses known in the art are affected by several drawbacks. In particular, the most relevant problem affecting the prior art measuring apparatuses and/or methods relates to the fact that these methods and/or apparatuses do not allow the simultaneous, reliable detection of both the level of molten metal and the depth of molding powder. In particular, since it is not possible, with the known methods and apparatuses, to distinguish between the depth of molding powder and the real level of molten metal, the values measured may not be used for gauging in a reliable manner these two parameters. This is due, in particular, to the fact that the values measured only give an indication of the total level of the material inside the mold (molten metal and molding powder) but do not allow one to obtain reliable measures of these two parameters simultaneously. In other words, the measured values only give an indication of the total level of material contained in the mold, this total level arising from both the level of molten metal and the depth of molding powder.

Accordingly, it would be desirable to provide a measuring method and apparatus allowing one to overcome the drawbacks affecting the prior art methods and/or apparatuses. Moreover, it would be desirable to provide a method and apparatus for measuring both the level of molten metal and the depth of molding powder in a casting mold, allowing detection these two parameters in a reliable manner. It would likewise be desirable to provide a measuring method and apparatus allowing measurement of these two parameters simultaneously without requiring expensive and big computing equipment. It would further be desirable to provide a measuring method and apparatus adapted to be used in combination with several of the known casting processes and systems.

### SUMMARY

In one method and apparatus for measuring the depth of mold powder in a casting mold and the level of liquid metal in said casting mold, an electromagnetic open cavity is formed on the liquid metal and the depth of mold powder and the level of liquid metal are detected measured as a function of the electromagnetic behavior of the cavity. Still in more detail, the curve of resonance of the electromagnetic open cavity is detected and the depth of molding powder and the level of liquid metal are measured as a function of the bandwidth of the curve and the frequency of resonance of the electromagnetic open cavity.

Because in this method and apparatus, the depth of molding powder and the level of molten metal in the mold are measured simultaneously, it is also possible to gauge control during the casting process, both the depth of molding powder and the level of molten metal in the mold.

In another embodiment, a measuring device is provided for measuring predefined parameters of a liquid metal in a container, the container comprising an inlet aperture through which the liquid metal is introduced into the container, characterized in that the measuring device is adapted to be placed on said inlet aperture of said container so as to form, in combination with the container, an electromagnetic open cavity, and in that said measuring device comprises detecting means adapted to detect the electromagnetic behavior of the cavity so as to obtain said predefined parameters as a function of the electromagnetic behavior.

In another embodiment, a casting apparatus is provided for use in a continuous casting process, wherein the apparatus comprises a casting container with an inlet aperture for receiving liquid metal and an outlet aperture for discharging solidified metal. The container is adapted to contain a predefined amount of liquid metal. The apparatus is equipped with a measuring device. The measuring device is placed on the inlet aperture so as to form, in combination with the container and the liquid metal contained therein, an electromagnetic open cavity.

In another embodiment, a method is provided for measuring predefined parameters of a liquid molten metal in a container, wherein the container comprises an inlet aperture through which the liquid metal is introduced into the container. In the method, the steps are performed of forming an electromagnetic open cavity above the liquid metal, detecting the electromagnetic behavior of the cavity, and obtaining the predefined parameters as a function of said electromagnetic behavior.

In another continuous casting process, liquid metal is introduced into a continuous casting mold, and solidified metal is extracted from the mold. The process includes measuring predefined parameters of the liquid metal in the mold.

The embodiments provided herein employ the realization of an electromagnetic open cavity above the liquid metal and the overlying molding powder, so that predefined parameters of both the molten metal and the molding powder may be detected as a function of the electromagnetic behavior of the electromagnetic open cavity. The electromagnetic behavior of the electromagnetic cavity is correlated with the depth of molding powder and the level of molten metal in the mold. In particular, if the curve of resonance of the electromagnetic cavity is detected, the depth of molding powder and the level of molten metal can be measured as a function of the bandwidth of said curve of resonance and the frequency of resonance of the cavity.

### DESCRIPTION OF THE DRAWINGS

In the following, a description will be given with reference to the drawings of particular preferred embodiments; it has, however, to be noted that the present invention is not limited to the embodiments disclosed but that the embodiments disclosed only relate to particular examples of the present invention, the scope of which is defined by the appended claims. In this disclosure:

FIG. 1 schematically depicts a prior art casting apparatus;

FIG. 2a depicts a cross sectional view of a component part of a measuring device;

FIGS. 2b and 2c, respectively, relate to corresponding exploded views of the component part depicted in FIG. 2a ;

FIG. 3a depicts in a cross-sectional view a measuring device;

FIG. 3b relates to a perspective view of the measuring device;

FIG. 4 relates to a perspective view of a preferred embodiment of an emitting/receiving device of the measuring device;

FIG. 5a depicts a cross sectional view of a casting mold equipped with a measuring device;

FIG. 5b relates to a perspective view of the casting mold of FIG. 5a;

FIGS. 6a and 6b schematically depict two particular embodiments of the measuring device, respectively;

FIG. 7 depicts an example of the data detectable by means of the measuring device;

FIGS. 8a and 8b show corresponding examples of the data that is obtainable by processing the curves depicted in FIG. 7; and

FIGS. 9a and 9b relate to examples of the way predefined parameters relating to the molding powder and the molten metal in a casting mold may be computed by manipulating the data depicted in FIGS. 7, 8a and 8b.

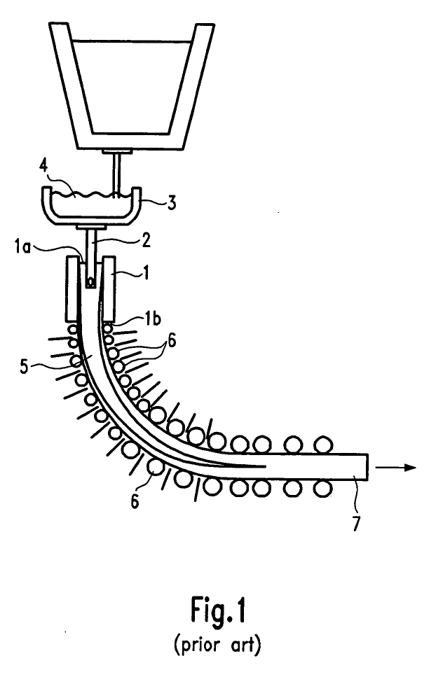

### DETAILED DESCRIPTION

While the invention is described with reference to the embodiments as illustrated in the following detailed description as well as in the drawings, it should be understood that the following detailed description as well as the drawings are not intended to limit the present invention to the particular illustrative embodiments disclosed, but rather the described illustrative embodiments merely exemplify the various aspects of the present invention, the scope of which is defined by the appended claims.

The systems and methods described herein are particularly advantageous when used for detecting and/or measuring the depth of molding powder and the level of molten metal in a casting mold during a continuous casting process. For this reason, examples will be given in which corresponding methods and devices are applied to a continuous casting process and a continuous casting apparatus and are used for measuring the depth of molding powder and the level of molten metal in a casting mold. However, it has to be noted that the invention is not limited to the particular case of a continuous casting process carried out by means of a continuous casting apparatus comprising a casting mold, but can be used in any other situation in which predefined parameters of a molten or liquid metal in a container need to be measured and/or detected. In particular, it will become apparent from the following disclosure that these systems and methods are also applicable in other cases in which it is possible to realize an electromagnetic open cavity above the molten and/or liquid metal. It will also become apparent from the following disclosure that the present invention is applicable in all those cases in which the molten and/or liquid metal is contained in a container comprising an upper aperture so that an electromagnetic open cavity may be formed by placing a cover on the upper aperture, the electromagnetic open cavity being thus defined by the cover, in cooperation with the walls of the container and the molten metal in the container. In more detail, the features of the electromagnetic cavity relating the fact that the cavity is an “open” cavity is provided by means of apertures in the cover adapted to opportunely influence the electromagnetic behavior of the cavity. It has, therefore, to be understood that the systems and methods described herein are applicable for detecting and/or measuring all those parameters of a molten metal, for which a relationship may be established between those parameters and the electromagnetic behavior of the cavity and/or the electromagnetic features of electromagnetic signals exiting the cavity.

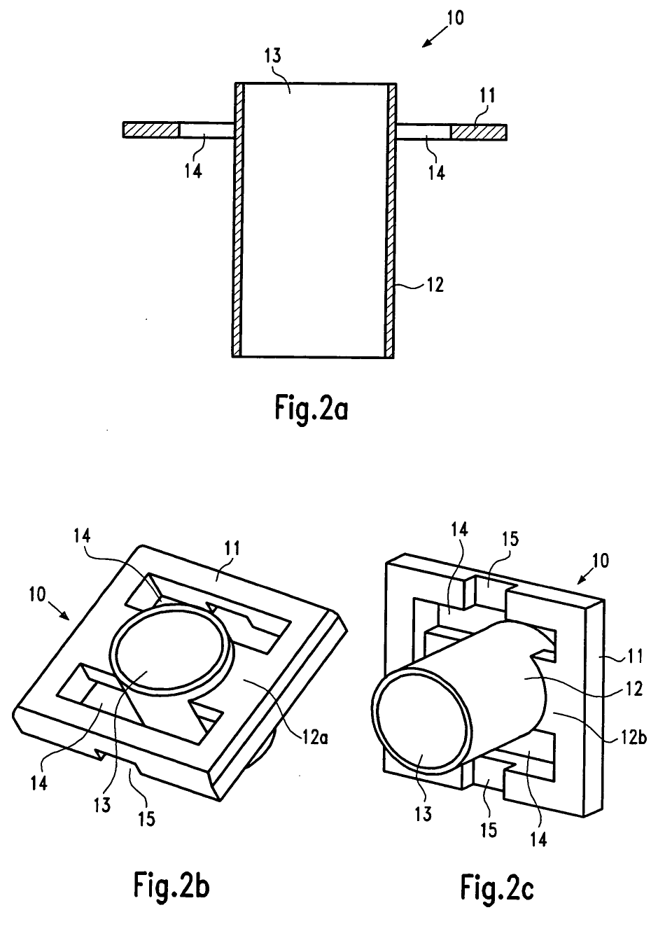

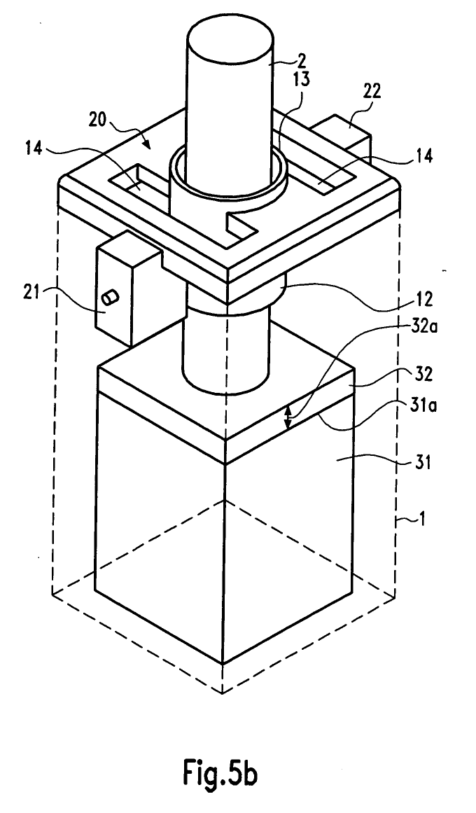

In FIG. 2a, reference numeral 10 identifies a metal plate or cover; as it will become more apparent from the following description, the metal plate or cover belongs to a measuring device and is adapted to be placed on the top (on the top inlet aperture) of a container, for instance a casting mold, so as to define, in cooperation with the container and the molten metal contained therein, an electromagnetic open cavity. To this end, the metal plate or cover 10 depicted in FIG. 2a comprises a main plate 11 with two top apertures 14, the shape and dimensions of which may be opportunely selected to determine the electromagnetic behavior of the electromagnetic cavity underlying the plate or cover 10. In particular, the shape and dimensions of the apertures 14 may be selected so as to define the resonance mode of electromagnetic field in the cavity in a given frequency band. The metal plate or cover 10 further comprises in its central portion, a tube or pipe 12 with a central through aperture 13. Also the dimensions (diameter and length) of the central pipe or tube 12 are selected so as to opportunely influence the electromagnetic cavity underlying the plate 10, in particular, to determine the resonance mode of electromagnetic field in the cavity. Moreover, as it will become more apparent in the following, the tube or pipe 12 is adapted to receive an inlet nozzle 2 (see FIG. 5a) provided for introducing molten and/or liquid metal in the container underlying the cover 10.

With reference now to FIGS. 2b and 2c, wherein identical or corresponding parts are identified by the same reference numerals, it can be seen that the tube or pipe 12 is maintained in its central position by means of an intermediate plate 12a; in particular, by means of the intermediate plate 12a, the tube or pipe 12 is maintained in a position perpendicular to the main plate 11. In FIGS. 2b and 2c, reference numeral 15 identifies corresponding notches and/or indentations provided in the main plate 11. These notches and/or indentations are provided for the purpose of fixing to the cover 10 emitting and receiving devices adapted to introduce and receive electromagnetic signals into and from the electromagnetic open cavity underlying the cover 10, respectively. The length of the tube 12 in particular, the length of the portion of the tube 12 under the main plate 11 is selected so that the tube 12 does not come into contact with the molten metal underlying the cover 10. While the reason for that will be explained in more detail in the following, it can be appreciated that the tube 12 helps in defining and/or determining the resonance mode of the electromagnetic signals transmitted through the cavity.

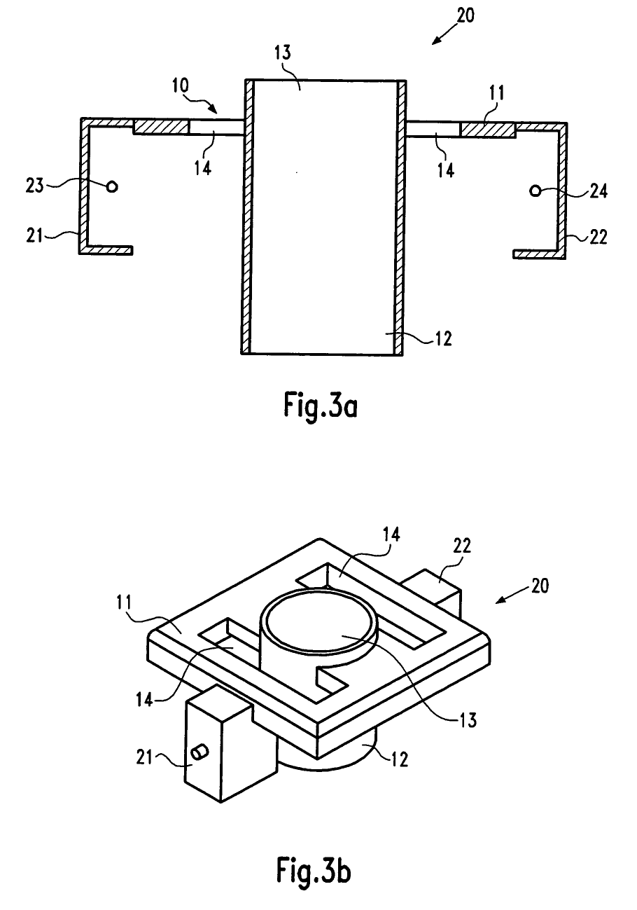

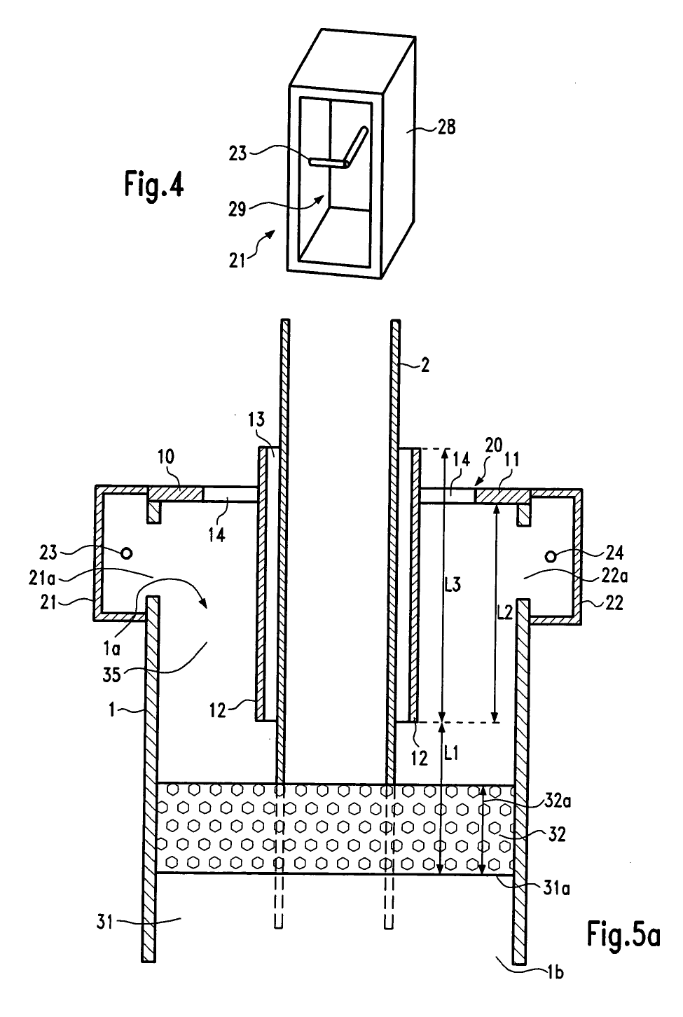

In the following, with reference to FIGS. 3a and 3b, a measuring device will be described in detail. In particular, in FIG. 3a, reference numeral 10 identifies a metal plate or cover as described above with reference to FIGS. 2a to 2c; accordingly, those features of the cover 10 described above with reference to FIGS. 2a to 2c are identified in FIGS. 3a and 3b by the same reference numerals. As is apparent from FIG. 3a, the measuring device 20 comprises, in addition to the cover 10, an emitting device 21 and a receiving device 22. The emitting device 21 is provided for the purpose of introducing the electromagnetic signals into the cavity underlying the measuring device 20; in a similar way, the receiving device 22 is provided for the purpose of receiving the electromagnetic signals emitted by the device 21 and transmitted through the electromagnetic open cavity underlying the measuring device 20. In the particular example depicted in FIG. 3a, the emitting device 21 comprises a current loop 23 (see also FIG. 4) adapted to be connected to a coaxial cable (not depicted in the drawings). However, it will be appreciated that different emitting devices may be provided for the purpose of emitting electromagnetic signals, without departing from the scope of the present invention; the same applies for the receiving device 22.

In FIG. 3b, the measuring device 20 is depicted in a perspective view. In particular, it can be seen from FIG. 3b that the emitting and the receiving device 21 and 22 are fixed to the cover 10 on opposite sides of the main plate 11, respectively. Moreover, said emitting and receiving devices 21 and 22 are fixed to the main plate 11 in correspondence of the indentations or notches 15 described above with reference to FIGS. 2b and 2c.

FIG. 4 depicts an emitting device in an exploded view adapted to be used in a measuring device. To this end, the emitting device comprises a current loop 23 adapted to be connected with a coaxial cable (not depicted in the drawings). In particular the geometry of the current loops is designed in order to obtain the desired field distribution inside the cavity. The current loop 23 is received in the main body 28 having a box-like shape, with this main body comprising an aperture 29. As it will be explained in more detail below, during use, i.e. when the emitting device 21 is fixed to the cover 10 described above with reference to FIGS. 2a to 2c, the aperture 29 is placed in correspondence of an aperture 21a (see FIG. 5a) provided in a wall of the container or mold containing the molten metal. In this way, electromagnetic signals generated by the current loop 23 (or by means of devices adapted to this end and known to those skilled in the art) may be introduced into the container containing the molten metal, i.e. into the electromagnetic open cavity defined, in combination, by the measuring device 20, the walls of the container and the molten metal received therein.

For the purpose of receiving the electromagnetic signals emitted by the emitting device 21 of FIG. 4 and transmitted through the electromagnetic open cavity, a device may be used along those known in the art; in particular, said emitting device may have a shape similar to that of the emitting device 21, i.e. the receiving device may comprise a main body with a box-like shape, with said main body comprising an aperture adapted to be placed in correspondence of an aperture of the container for the molten metal. The electromagnetic signals exiting the cavity are, therefore, captured by the box-like shaped main body and may be detected by means of detecting devices adapted to this end. Since a large class of receivers known in the art may be used in the measuring device, it is considered that a more detailed description of said emitting device may be avoided.

FIGS. 5a and 5b depict a cross-sectional view and an exploded view, respectively, of a container for molten metal, for instance a casting mold, equipped with a measuring device. In particular, in FIGS. 5a and 5b, the measuring device is identified by the reference numeral 20 whilst the container for molten metal is identified by the reference numeral 1. The molten metal in the container 1 is identified by the reference numeral 31 whereas the upper surface and/or upper level of said molten metal is identified by the reference numeral 31a. In FIG. 5a, reference numeral 32 identifies molding powder floating on the molten metal 31 and introduced into the container 1 for purposes relating to the casting process. The depth of the molding powder 32 is identified in FIGS. 5a and 5b by the reference numeral 32a. The inlet and outlet apertures of the container or mold 1 are identified in FIG. 5a by the reference numerals 1a and 1b, respectively. In FIGS. 5a and 5b, those portions and/or component parts already described with reference to previous drawings are identified by the same reference numerals. Accordingly, reference numeral 20 identifies a measuring device comprising a cover 10 with a main plate 11 comprising two rectangular apertures 14; moreover, an emitting device 21 and a receiving device 22 are fixed to the cover 10 on opposite sides thereof, with apertures of the emitting and receiving device being placed in proximity of corresponding apertures 21a and respectively, of the container or mold 1. Additionally, in FIG. 5a, references L1, L2 and L3 identify the distance between the lower portion of the tube 12 and the upper surface of the molten metal, the distance between the lower portion of the tube 12 and the lower surface of the cover 10 and the overall length of the tube 12, respectively.

During a continuous casting process, molten metal is introduced into the container or mold 1 through the nozzle 2 received inside the tube 12 of the measuring device 20 and the metal is discharged from the container 1 through the outlet aperture 1b. Moreover, molding powder is introduced into the container or mold 1, for instance through one or both of the apertures 14 of the main plate 11 of the cover 10. As it will be explained in more detail below, the measuring device 20 (comprising the main cover 10, the tube 12 and the emitting and receiving devices 21 and 22) defines, in combination with the walls of the container 1 above the molding powder 32 and the molten metal 31, an electromagnetic open cavity 35. The electromagnetic properties of the open cavity 35 may be used for detecting predefined parameters of both the molten metal 31 and the molding powder 32 contained in the container or mold 1. In particular, it has been established that a relationship always exists between the couple of the geometrical quantities 31a and 32a and the couple of the electromagnetic parameters defined by the frequency of resonance of the cavity 35 and the bandwidth of the frequency response. Accordingly, if the electromagnetic behavior of the cavity 35 is detected, it is also possible to compute and/or calculate the level of molten metal 31a and the depth of molding powder 32a in the container.

The equipment depicted in FIGS. 5a and 5b, comprising essentially a container or mold 1 with a molten metal 31 received inside the container and molding powder 32 floating over the molten metal, and a measuring device 20 placed on the inlet aperture 1a of the container 1 may be regarded, from the electromagnetic point of view (and along the axis of symmetry of the nozzle 2) as a length of coaxial cable comprising an external conductive element defined by the walls of the container 1 and an internal conductive element whose circular cross sectional shape is represented by the nozzle 2. Moreover, in the equipment or apparatus of FIGS. 5a and 5b, the external and internal conductive elements are short circuited by the upper surface 31a of the liquid or molten metal 31, with the molding powder 32 representing a dielectric element floating on the molten metal 31. It is known that, in a structure of the kind schematically represented in FIGS. 5a and 5b, the fundamental propagation mode along the axis of symmetry of the nozzle 2 is of the kind TEM; this fundamental propagation mode may be confined for the purpose of creating or defining a resonant cavity only by means of an electrical contact between the external and internal conductive elements. An electrical contact is provided in the lower part of the cavity by the upper surface 31a of the molten metal 31. But, for evident mechanical reasons, the inlet nozzle 2 can not be brought into contact with either the walls of the container 1 or the cover 10 of the measuring device 20. Moreover, the nozzle 2 can not be brought into contact with the tube 12. For these reasons the structure is an open cavity, so that the TEM fundamental transmission mode is preferably not used for the purpose of detecting the parameters of interest. Accordingly, a higher-order propagation mode is preferably used, in particular, the emitting device 21 is designed to launch this higher-order mode. Furthermore, this higher order propagation mode is strongly attenuated inside the tube 12, while in correspondence with the aperture 14, the higher-order mode is almost totally reflected by means of the plate 12a (see FIG. 2c) connecting the tube 12 to the main plate 11.

The equipment depicted in FIGS. 5a and 5b allows, therefore, the definition or realization of an electromagnetic open cavity above the molten metal 31 and the molding powder 32; accordingly, since the electromagnetic behavior properties of said cavity 35 depends from and are directly related to the level 31a of molten metal and the depth of molding powder 32a, detecting said electromagnetic behavior and/or properties allows the indirect detection of said two parameters. In particular, as it will be explained in more detail in the following, if the curve of resonance of the cavity 35 is detected, a relationship can be established between the frequency response of the cavity and the couple of parameters: the level of molten metal and the depth of molding powder. Accordingly, during a measuring process carried out for the purpose of detecting both the level of molten metal in the mold and the depth of molding powder floating over the molten metal, electromagnetic signals emitted by the emitting device 21 within a predefined frequency range are introduced into the container 1 (i.e. into the electromagnetic open cavity 35) through the aperture 21a of the container 1. Moreover, said electromagnetic signals traveling across the cavity 35 are captured by the receiving device 22; once received by the receiving device 22, the electromagnetic signals are detected and processed so as to determine the electromagnetic properties of the cavity. The level of the molten metal and the depth of molding powder can, therefore, be computed as a function of the detected electromagnetic signals.

According to a preferred embodiment of the measuring method, consecutive electromagnetic signals of corresponding different frequencies are introduced into the cavity 35 according to a predefined time schedule. In particular, for the purpose of detecting the curve of resonance of the cavity, approximately 100 electromagnetic signals with corresponding different frequencies may be introduced into the cavity, with a time interval between two consecutive signals of about 1 microsecond.

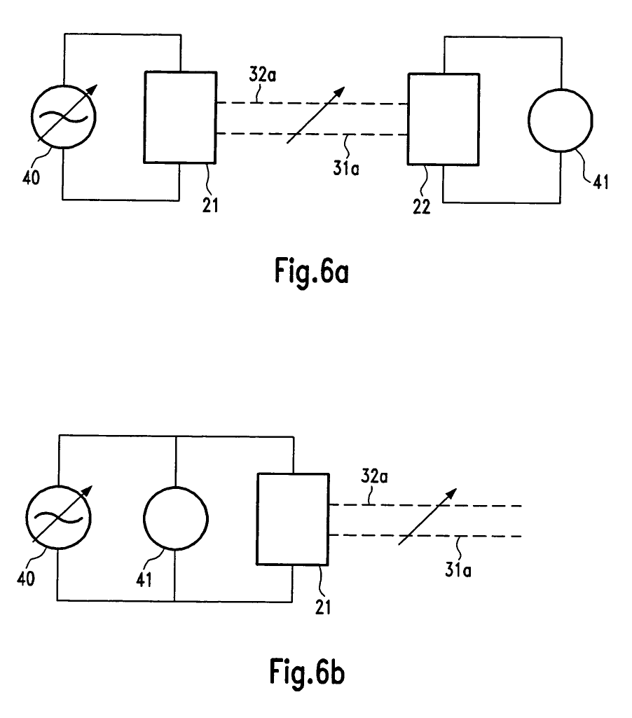

The equipment depicted in FIGS. 5a and 5b may be schematically represented as depicted in FIGS. 6a and 6b. As apparent from FIG. 6a, the emitting device 21 is electrically connected to a device 40 adapted to generate alternating electrical signals. Moreover, the receiving device 22 is connected to detecting means 41. In the scheme of FIG. 6a, the metal level 31a and the depth of molding powder 32a are ideally represented by the dashed lines between the emitting device 21 and the receiving device 22. The electromagnetic signals emitted by the emitting device 21 and received by the receiving device 22 are influenced by both the level 31a of molten metal and the depth 32a of molding powder. Accordingly, detecting the electromagnetic signals received by the receiving device 22 allows one to obtain indications of these two parameters.

In FIG. 6b, there is depicted a further electrical configuration of a measuring device; in particular, in the configuration of FIG. 6b, the device 40 and the detecting means 41 are provided on the same side of the cavity and both electrically connected to the emitting device 21. These configurations may be realized by using digital and/or analog devices.

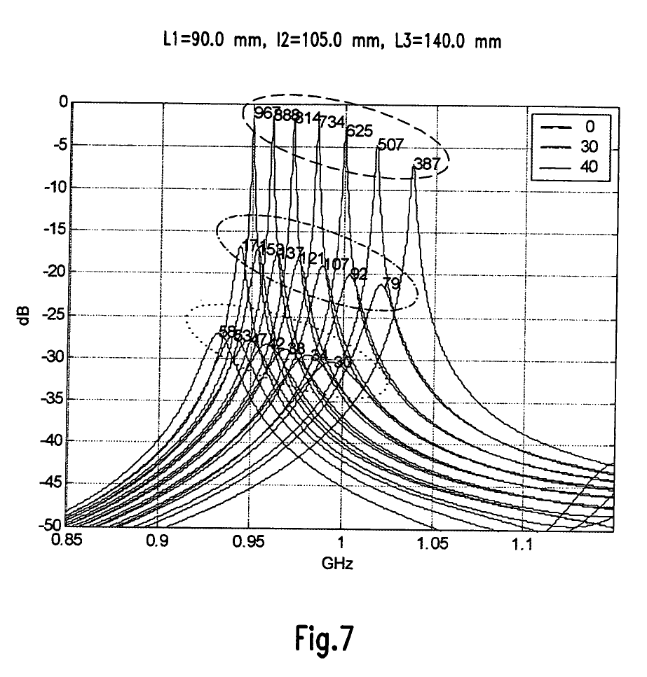

The electromagnetic behavior of the cavity 35 formed by the equipment depicted in FIGS. 5a and 5b has been analyzed by means of full-wave techniques; the results of this detection are shown in FIGS. 7, 8a, 8b, 9a and 9b. In particular, in FIG. 7, there are depicted the frequency responses of the cavity as a function of the level of molten metal and the depth of molding powder present in the container 1 as depicted in FIGS. 5a and 5b. In particular, the frequency responses of FIG. 7 relate to equipment wherein L1 (distance between the lower end portion of the tube 12 and the upper surface of the molten metal) corresponds to 90 mm, L2 (distance between the lower end portion of the tube 12 and the lower surface of the main plate 11) corresponds to 105 mm and L3 (overall length of the tube 12) corresponds to 140 mm. The curves depicted in FIG. 7 represent the curves of resonance of the cavity, wherein the intensity of the signals received is reported as a function of the frequency at which said signals were emitted. In more detail, in FIG. 7, the curves identified by the dashed circle represent the curve of resonance of the cavities in the case in which no molding powder is floating on the molten metal. The curves identified by the dash-dotted circle represent the curves of resonance in the case in which the depth of molding powder corresponds to 30 mm. Finally, the curves identified by the dotted circle represent the curves of resonance of the cavity in the case in which the depth of molding powder corresponds to 40 mm. Finally, for each group of curves, each different curve relates to a corresponding different level of molten metal inside the container. As apparent from FIG. 7, when the level of molten metal increases, also the frequencies of resonance increase. Moreover, when the depth of molding powder increases, the intensity of the electromagnetic signals received (the intensities at the frequencies of resonance) decrease and the bandwidth of each curve of resonance becomes larger. A two-dimensional relationship may, therefore, be established between the frequency of resonance of the cavity and the bandwidth of the frequency response from one hand, and the level of molten metal and the depth of molding powder on the other hand.

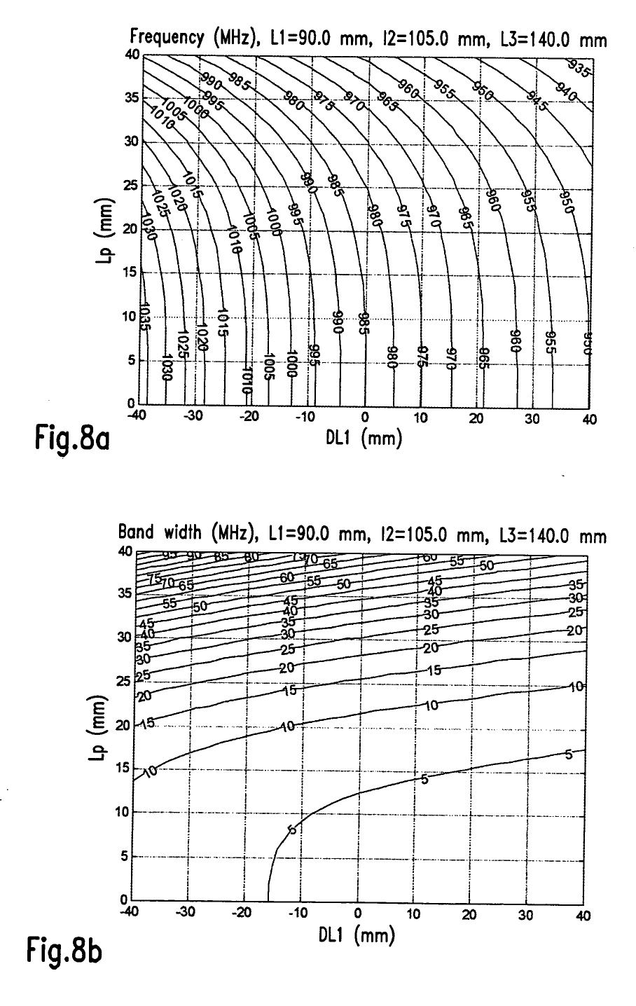

For the purpose of accurately detecting the behavior of the equipment depicted in FIGS. 5a and 5b (i.e. of the resonant cavity 35) there are depicted in FIG. 8a the iso-level curves of the frequency of resonance as a function of the level of molten metal and the depth of molding powder within the equipment. In particular, FIG. 8a corresponds to the case of a level of molten metal varying from 50 mm to 130 mm; (this is to say that in FIG. 8a, the value 0 along the X axis corresponds to a nominal level of molten metal of 90 mm) and of a depth of molding powder varying from 0 to 40 mm (Y axis in FIG. 8a). In FIG. 8a, the several iso-level lines depicted therein join the possible combinations of values of the depth of molding powder and the level of molten metal. In the same way, in FIG. 8b, there are depicted the iso-level curves or lines of the bandwidth of the curves of resonance of the equipment (i.e. of the resonant open cavity). Again, in the case of FIG. 8b, the level of molten metal varies from 40 mm to +40 mm, about a nominal level of 90 mm (X axis in FIG. 8b), and the depth of molding powder varies from 0 to 40 mm (Y axis in FIG. 8b). Moreover, in the case of FIG. 8b, the bandwidths were measured for values of intensity of the signals corresponding to the intensity at the resonance frequency diminutive of 10 dB.

It appears from FIG. 8a that the resonance frequency does not only depend on the level of molten metal and from FIG. 8b that the bandwidth of the frequency response does not only depend on the depth of molding powder. However, the two families of iso-level curves are substantially perpendicular to each other. Therefore, the two-dimensional relationship represented in FIGS. 8a and 8b can be inverted in order to find out the level of molten metal and the depth of molding powder from the measured resonance frequency and the measured bandwidth of the frequency response.

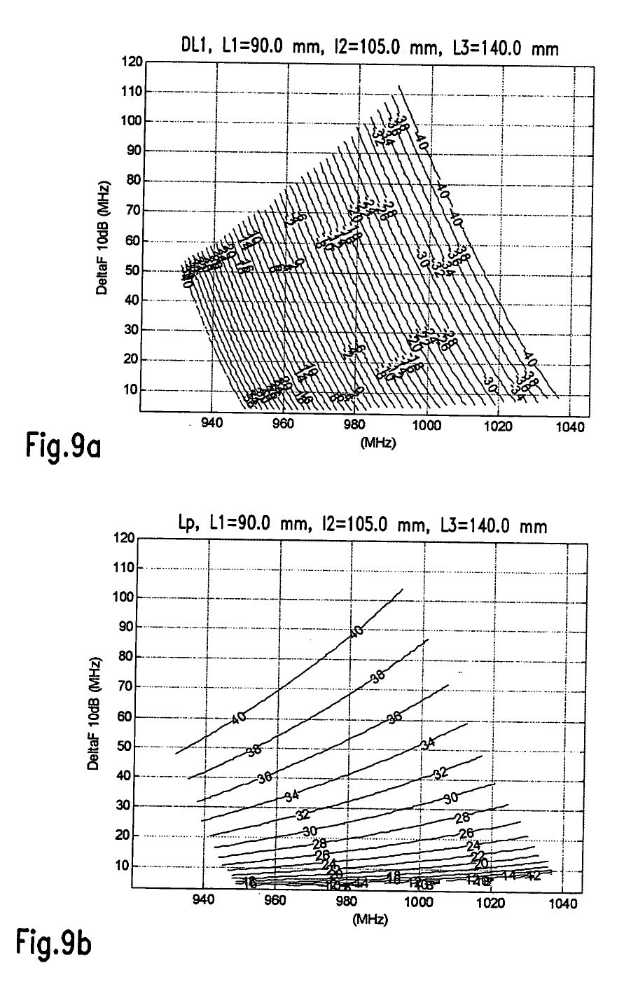

The results of this inversion are depicted in FIGS. 9a and 9b. FIGS. 9a and 9b show that it is possible to obtain the depth of the molding powder and the level of molten metal as a function of the frequency response of the electromagnetic open cavity. In particular, it arises from FIG. 9a that for a variation of the level of liquid metal of about 1 mm, the corresponding variation of the frequency of resonance is within 1 MHz and the corresponding variation of the bandwidth is within 3.5 MHz; it results, therefore, that with respect to the level of liquid metal, the sensitivity of the measuring equipment corresponds to about 1 MHz/mm for the resonance frequency and 3.5 MHz/mm for the bandwidth. In the same way, it results from FIG. 9b that for a variation of the depth of molding powder of about 2 mm, the corresponding variation of the bandwidth of the curve of resonance of the cavity (by −10 dB) is within 10 MHz and the variation of the resonance frequency is within 20 MHz; accordingly, with respect to the depth of molding powder, the sensitivity of the equipment may be estimated to be approximately 5 MHz/mm for the bandwidth, and 10 MHz/mm for the resonance frequency.

It results, therefore, from the above that detecting means with standard electronic equipment may be used for the purpose of appreciating variations in the level of molten metal and in the depth of molding powder within an accuracy of 1 mm.

In conclusion, the methods and systems described herein allow the measurement of the level of molten metal in the casting mold and the depth of molding powder floating over the molten metal. These two parameters may be measured simultaneously as a function of different properties of an electromagnetic open cavity formed inside the casting mold. It is possible, therefore, to overcome the most important drawbacks affecting those prior art measuring devices and methods that only allow the measuring of a single parameter comprehensive of both the molten metal and the molding powder flowing over the metal. Moreover, the measuring methods and devices described herein may be used with a large class of the casting systems known in the art. Furthermore, standard electronic equipment may be used for the purpose of measuring the level of molten metal and the depth of molding powder in a reliable manner, with an evident advantage concerning the overall costs of the equipment. Finally, the measuring methods and devices described herein do not need to be used in combination with devices and/or means for gauging both the depth of the molding powder and the level of molten metal in the casting mold.

Of course, it should be understood that a wide range of changes and modifications can be made to the embodiments described above without departing from the scope of the present invention. For instance, said changes and modifications may relate to the kind of emitting and receiving means used for introducing electrical signals into the cavity and for receiving the electrical signals exiting the cavity for the purpose of detecting the electromagnetic behavior and/or properties of the cavity.

1. A measuring device for measuring predefined parameters of a liquid metal in a container, the container comprising an inlet aperture through which the liquid metal is introduced into the container, wherein:
the measuring device is adapted to be placed on said inlet aperture of said container so as to form, in combination with the container, an electromagnetic open cavity; and
the measuring device comprises detecting means adapted to detect the electromagnetic behavior of the cavity so as to obtain said predefined parameters as a function of the electromagnetic behavior.

2. A measuring device as claimed in claim 1, wherein:
the measuring device comprises an emitting device and a receiving device adapted to introduce electromagnetic input signals into the cavity and to receive output electromagnetic signals from the cavity, respectively, through corresponding input and output apertures of the container.

3. A measuring device as claimed in claim 2, wherein:
the emitting device is adapted to introduce electromagnetic signals into the cavity within a predefined frequency range.

4. A measuring device as claimed in claim 3, wherein:
the detecting means are coupled to said receiving device and are adapted to detect the curve of resonance of the cavity.

5. A measuring device as claimed in claim 4, wherein:
the detecting means are adapted to detect the bandwidth of the curve of resonance.

6. A measuring device as claimed claim 4, wherein:
the emitting device is adapted to introduce the electromagnetic signals into the cavity according to a predefined time schedule.

7. A measuring device as claimed claim 4, wherein:
the device further comprises computing means adapted to calculate the parameters as a function of both the frequency of resonance of the cavity and the bandwidth of the curve of resonance.

8. A measuring device as claimed in claim 1, wherein:
the device comprises a cover adapted to be placed on the inlet aperture of said container, with said cover comprising a main plate with at least one through aperture, the shape and dimension of which are adapted to influence the electromagnetic behavior of the cavity.

9. A measuring device as claimed in claim 8, wherein:
the cover comprises at least two apertures of a rectangular shape.

10. A measuring device as claimed in claims 8, wherein:
the device further comprises a tube firmly fixed to the main plate and disposed transversely with respect to the main plate.

11. A casting apparatus of the kind adapted to be used in a continuous casting process, the apparatus comprising a casting container with an inlet aperture for receiving liquid metal and an outlet aperture for discharging solidified metal, the container being adapted to contain a predefined amount of liquid metal, wherein:
the casting apparatus is equipped with a measuring device on the inlet aperture of said container so as to form, in combination with the container, an electromagnetic open cavity; and
the measuring device comprises detecting means adapted to detect the electromagnetic behavior of the cavity so as to obtain said predefined parameters as a function of the electromagnetic behavior.

12. A casting apparatus as claimed in claim 13, further comprising:
means for introducing molding powder into the container;
wherein the depth of molding powder in the container is detected as a function of the bandwidth of the frequency response and the resonance frequency of said cavity.

13. A casting apparatus as claimed in claim 12, further comprising means for adjusting the depth of molding powder in the container as a function of the depth of molding powder as detected.

14. A casting apparatus as claimed in claim 12, wherein the level of liquid metal in the container is detected as a function of the frequency of resonance and the bandwidth of the frequency response of the cavity.

15. A casting apparatus as claimed in claim 14, further comprising means for adjusting the level of liquid metal in the container as a function of the level as detected.

16. A measuring method for measuring predefined parameters of a liquid metal in a container, wherein the container comprises an inlet aperture through which the liquid metal is introduced into the container, the measuring method comprising:
forming an electromagnetic open cavity above the liquid metal;
detecting the electromagnetic behavior of the cavity; and
obtaining the predefined parameters as a function of said electromagnetic behavior.

17. A measuring method as claimed in claim 16, further comprising:
introducing electromagnetic input signals into the cavity; and
receiving electromagnetic output signals from the cavity.

18. A measuring method as claimed in claim 17, wherein electromagnetic signals within a predefined frequency range are introduced into the cavity.

19. A measuring method as claimed in claim 18, further comprising detecting the curve of resonance of the cavity.

20. A measuring method as claimed in claim 19, further comprising detecting the bandwidth of the curve of resonance.

21. A measuring method as claimed in claim 19, wherein the electromagnetic signals are introduced into the cavity according to a predefined time schedule.

22. A measuring method as claimed in claim 19, further comprising calculating the parameters as a function of both the frequency of resonance of the cavity and the bandwidth of the curve of resonance.

23. A measuring method as claimed in claim 16, wherein:
the container is a casting container adapted to be used in a continuous casting process and comprises an outlet aperture for discharging solidified metal; and
the electromagnetic open cavity is defined by means of a cover, the cover comprising a main plate with at least one through aperture, the shape and dimension of which are adapted to influence the electromagnetic behavior of the cavity.

24. A measuring method as claimed in claim 23, wherein the main plate comprises at least two apertures of a rectangular shape.

25. A measuring method as claimed in claim 23, wherein the electromagnetic behavior of the cavity is further influenced by means of a tube firmly fixed to the main plate and disposed transversely with respect to the cover.

26. A measuring method as claimed in claim 23, wherein the container is further adapted to contain molding powder (32) above said liquid metal and in that the depth of molding powder in the container is detected as a function of the bandwidth of the frequency response and of the resonance frequency of the cavity.

27. A measuring method as claimed in claim 26, wherein the level of liquid metal in the container is detected as a function of the frequency of resonance and of the bandwidth of the frequency response of the cavity.

28. A continuous casting process comprising introducing liquid metal into a continuous casting mold and extracting solidified metal from said mold, said process further comprising measuring predefined parameters of the liquid metal in the mold, wherein the predefined parameters are measured in a method comprising:
forming an electromagnetic open cavity above the liquid metal;
detecting the electromagnetic behavior of the cavity; and
obtaining the predefined parameters as a function of said electromagnetic behavior.

29. A process as claimed in claim 28, further comprising introducing molding powder into the mold, wherein the detected parameters comprise one or both of the level of liquid metal in the mold and the depth of molding powder.

30. A process as claimed in claim 29, wherein the depth of molding powder is detected as a function of the bandwidth of the curve of resonance and of the resonance frequency of the cavity.

31. A process as claimed in claim 30, wherein the process further comprises adjusting the depth of molding powder in the mold as a function of the depth of molding powder as detected.

32. A process as claimed in claim 30, wherein the level of liquid metal in the mold is detected as a function of the frequency of resonance and the bandwidth of the frequency response of the cavity.

33. A process as claimed in claim 32, further comprising the step of adjusting the level of liquid metal in the mold as a function of the level as detected.
